(19) United States
(12) Patent Application Publication
(10) Pub. No.: US 2011/0150365 A1
(43) Pub. Date: Jun. 23, 2011

(54) SYSTEM FOR EVALUATING AND CERTIFYING ROI-BASED IMAGE IDENTIFY TECHNOLOGY

(75) Inventor: Weon Geun OH, Daejeon (KR)

(73) Assignee: Electronics and Telecommunications Research Institute, Daejeon (KR)

(21) Appl. No.: 12/858,145

(22) Filed: Aug. 17, 2010

(30) Foreign Application Priority Data
Dec. 18, 2009 (KR) 10-2009-0127370
Jun. 11, 2010 (KR) 10-2010-0055676

(51) Int. Cl. G06K 9/54

(52) U.S. Cl. 382/305

(57) ABSTRACT

The present invention relates to a system for certifying an image identify technology. The system for certifying an image identify technology according to an embodiment of the present invention includes a test image DB that stores still images and moving images; a modified image generator that generates modified images from the still images and the moving images; a modified image DB that stores the modified images; a statistical information unit that calculates statistical information by using results identifying the still images, the moving images, and the modified images by the image identify technology; an evaluator that evaluates the accuracy of the image identify technology according to the statistical information; and a certificate generator that generates certificate by using the statistical information and the accuracy.

### CROSS-REFERENCE TO RELATED APPLICATIONS

This application claims priority under 35 U.S.C. §119 to Korean Patent Application No. 10-2009-0127370, filed on Dec. 18, 2009, and Korean Patent Application No. 10-2010-0055676, filed on Jun. 11, 2010 in the Korean Intellectual Property Office, the disclosure of which is incorporated herein by reference in its entirety.

### BACKGROUND OF THE INVENTION

1. Field of the Invention

The present invention relates to a system for certifying an image identify technology, and more particularly, to a system for certifying an image identify technology for evaluating and certifying an ROI-based still image identify technology.

2. Description of the Related Art

With the increase in the demand for digital contents, a vast amount of multimedia contents (video, music, image, etc.) have been ceaselessly created, produced, distributed, and served around us. Among others, the number of digital still images (hereinafter, referred to as still images) have explosively increased due to the spread of high-performance portable digital camera or the drop in price of a large-capacity storage apparatus or a portable storage medium. On the other hand, the demand for a product that efficiently searches the still images if necessary and accurately identifies and searches the desired targets from other targets has increased gradually.

The technology for identifying and searching the still image may be largely divided into three stages according to difficulty and application purpose.

The first stage includes a technology for identifying the exactly same image among large-capacity still images. This application field is a) contents search and confirmation of contents having no metadata and related information, b) trace of illegal use of contents with copyright, or the like.

The second stage includes a technology for identifying still images of which original characteristics (size, type, or quality, etc., of image) are modified by the Internet, a reproducing apparatus, or intentional editing. The application field is a) confirming use of illegal contents by a copyright holder, royalty collection, brand management, b) copyright management such as determination as to whether pressed contents are related to copyright, etc., c) personal image media management, etc., of various versions (time, place, device).

The third stage includes a technology for identifying contents including several still images based on a common region and an object when several images include a common region or the same object (character, building, background, place, etc.). The application field is a) searching and grouping of contents including the same region and object, b) content linking that links related contents based on presence and absence of the common region or the object at the time of Internet search.

The above three-stage technology is called an ROI-based image identifier.

In order to evaluate and certify the ROI-based image identifier, the identifier robust to the type, size, modified type, strength, etc., of the ROI, the evaluation information for evaluating their performance, and the certify technology for systematically evaluating and certifying a product are needed.

### SUMMARY OF THE INVENTION

It is an object of the present invention to evaluate and certify a ROI-based image identify technology through a system for certifying a still image identify technology and to provide a system for certifying an image identify technology.

The present invention is not limited to the above-mentioned object and other objects, which are not described above, can be obviously understood to those skilled in the art from the following description.

In order to achieve the above objects, according to an aspect of the present invention, there is provided a system for certifying an image identify technology according to an embodiment of the present invention, including: a test image DB that stores still images and moving images; a modified image generator that generates modified images from the still images and the moving images; a modified image DB that stores the modified images; a statistical information unit that calculates statistical information by using results identifying the still images, the moving images, and the modified images by the image identify technology; an evaluator that evaluates the accuracy of the image identify technology according to the statistical information; and a certificate generator that generates certificate by using the statistical information and the accuracy.

According to another aspect of the present invention, there is provided a system for certifying an image identify technology, including: a receiver that receives an image identify technology and certificate application from a user; an environment setting unit that sets an evaluation environment of the image identify technology according to the certificate application; a test image DB that stores still images and moving images; a modified image generator that sets regions of interest in the still images and the moving images, respectively, and modifies the set regions of interest to generate the modified images for each region of interest for the still images and the moving images; a statistical information unit that calculates statistical information by using results identifying the still images, the moving images, and the modified images for each region of interest by the image identify technology; an evaluator that evaluates the accuracy of the image identify technology according to the statistical information and the evaluation environment; and a certificate generator that generates certificate using the statistical information and the accuracy.

The details of other exemplary embodiments are included in the detailed description and the drawings.

According to embodiments of the present invention, it can evaluate and certify the ROI-based still image identify technology.

### BRIEF DESCRIPTION OF THE DRAWINGS

FIG. 1 is a block diagram showing a system for certifying an image identify technology according to an exemplary embodiment of the present invention.

### DETAILED DESCRIPTION OF THE PREFERRED EMBODIMENTS

Advantages and features of the present invention and methods to achieve them will be elucidated from exemplary embodiments described below in detail with reference to the accompanying drawings. However, the present invention is not limited to the exemplary embodiment disclosed herein but will be implemented in various forms. The exemplary embodiments is provided by way of example only so that a person of ordinary skill in the art to fully understand the disclosures of the present invention and the scope of the present invention. Therefore, the present invention will be defined only by the scope of the appended claims. Meanwhile, terms used in the present invention are to explain exemplary embodiments rather than limiting the present invention. In the specification, a singular type may also be used as a plural type unless stated specifically. “comprises” and/or “comprising” used herein does not exclude the existence or addition of one or more other components.

Hereinafter, exemplary embodiments of the present invention will be described in detail with reference to the accompanying drawings.

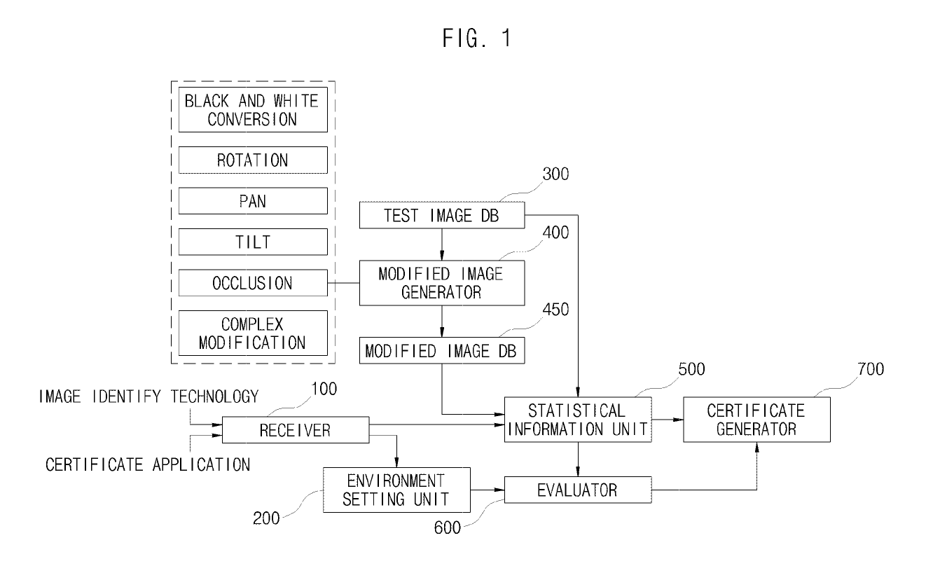

A system for certifying an image identify technology according to an exemplary embodiment of the present invention will be described with reference to FIG. 1. FIG. 1 is a block diagram showing a system for certifying an image identify technology according to an exemplary embodiment of the present invention.

Referring to FIG. 1, a system for certifying an image identify technology according to an exemplary embodiment of the present invention includes a test image database (DB) 300, a modified image generator 400, a modified image DB 450, a statistical information unit 500, an evaluator 600, and a certificate generator 700.

The test image DB 300 stores still images and moving images.

The modified image generator 400 generates modified images from the still images and the moving images.

The modified image DB 450 stores modified images.

The statistical information unit 500 calculates statistical information from the results of identifying still images, moving images, and modified image using an image identify technology.

The evaluator 600 evaluates the accuracy of the still image identify technology according to the statistical information.

The certification generator 700 generates a certificate by using the statistical information and the accuracy.

Meanwhile, the test image DB may be a set of still images and the moving images classified into various categories for evaluating the image identify technology.

In addition, the test image DB may be a query image for evaluating the accuracy of the image identify technology.

In addition, the test image DB may be a query target image for evaluating the accuracy of the image identify technology.

The test image DB according to the embodiment of the present invention may be classified into each category as the following Table. Further, each quantity for each category should be enough to evaluate the image identify technology as exemplified in the following Table. Each quantity may be varied according to the image identify technology. Therefore, the scope of the present invention is not limited thereto.

(a) Still Image (10,000 Sheet)

| Category | Quantity | |
|---|---|---|
| A. Animal (picture concerning animal) | 500 | sheet |
| B. Plant (picture concerning flower, tree, | 500 | sheet |
| etc.) | | |
| C. Food(picture concerning foods) | 500 | sheet |
| D. Character(picture concerning | 2,500 | sheet |
| person/character) | | |
| E. Traffic (picture concerning traffic means, | 500 | sheet |
| such as car, train, plane, ship) | | |
| F. Building(picture concerning building) | 500 | sheet |
| G. Thing(picture concerning thing such as | 2,000 | sheet |
| clothes, shoes, bag, TV, etc.) | | |
| H. Landscape(picture concerning landscape | 3,000 | sheet |
| having no specific object) | | |

(b) Moving Images (1,600 Shot)

| Category | Quantity |
|---|---|
| I. (a) HD 1080i(1920 × 1080) 16:9 moving image | each |
| concerning A-H | 100 shot |
| J. (a) HD 720p(1280 × 720) 16:9 moving image | each |
| concerning A-H | 100 shot |

Meanwhile, the moving image may include at least one of still or moving objects.

Further, the moving image may include a moving background or a still background.

Meanwhile, the modified image generator 400 sets the region of interest to calculate the accuracy of the image identify technology to generate the modified image for each region of interest from the still images and the moving images. The statistical information unit 500 may calculate the statistical information by further using the results of identifying the modified images for each region of interest by the image identify technology.

Meanwhile, the type of region of interest may be a rectangle.

Further, the size of region of interest may be close shot, middle shot, and full shot.

The close shot may be ½ or more of the entire image.

The middle shot may be between ¼ or more and under ½ of the entire image.

The full shot may be 1/9 or less of the entire image.

Further, the modified image generator 400 selects the modified function to generate the modified image for each region of interest from the still images and the moving images.

The modified function applies at least one of black-and-white conversion, rotation, pan, tilt, occlusion, and complex modification to the still images and the moving images. The complex modification may be a case when at least two of a black-and-white conversion, rotation, pan, tilt, occlusion, and complex modification are applied in combination.

Further, the modified image generator 400 selects the still image photographing environment to generate the modified image for each region of interest corresponding to the still image photographing environment from the still images.

In addition, the modified image generator 400 selects the resolution of the moving images and frames per second to generate the modified image for each region of interest corresponding to the resolution of moving image and the frames per second from the moving image.

Meanwhile, the modified image generator 400 may generate the modified image by a camera photographing scheme using a modified software.

In the test image class using the modified software, the test image class according to the modified level may have 6 types of 16 levels.

The detailed contents of the modified software as one embodiment are as follows.

| Type of | Modified level | | |
|---|---|---|---|
| modification | Heavy | Medium | Light |
| (1) color−> | No application | No application | I = 0.299R + |
| black-and-white | | | 0.587G + |
| conversion | | | 0.114B |
| (C2M) | | | |
| (2) rotation | 10° | 5° | 90° |
| (3) pan | 30° | 15° | 5° |
| (4) tilt | 15° | 10° | 5° |
| (5) occlusion | 30% of ROI | 15% of ROI | No occlusion |
| (6) Complex | (3) left and | (3) left and | (3) left and |
| modification | right rotation | right rotation | right rotation |
| | & (4) medium | & (4) medium | & (4) light |
| | value of up | value of up | value of up |
| | and down | and down | and down |
| | rotation | rotation | rotation |

The test image class according to the photographing environment may be 1 type of 4 cases.

| | Modified Case | | | |
|---|---|---|---|---|
| Type of modification | Case1 | Case2 | Case3 | Case4 |
| (1) Photographing | flash | sunset | rain | indoor |
| environment | | | | |

The test image class selected using moving images may be 2 types of 6 cases.

| | Modified Case | | |
|---|---|---|---|
| Type of moving image | Case1 | Case2 | Case3 |
| (1) Frame sampling of HD | 10 seconds | 5 seconds | 2 seconds |
| 1080i(1920 × 1080) 16:9, | | | |
| 30 fps digital film | | | |
| (2) Frame sampling of HD | 15 seconds | 10 seconds | 5 seconds |
| 720p (1280 × 720) 16:9 | | | |
| 60 fps digital film | | | |

In addition, the statistical information unit 500 uses the still image and the moving image as the query image and uses the modified image as the query target image to allow the image identify technology to identify the image corresponding to the query image among the query target images, thereby making it possible to calculate the statistical information using the identified results.

In addition, the statistical information unit 500 uses the modified image as the query image and uses the still image and the moving image as the query target image to allow the image identify technology to identify the image corresponding to the query image among the query target images, thereby making it possible to calculate the statistical information using the identified results.

Further, the statistical information unit 500 may calculate the statistical information for the modified function.

Meanwhile, the evaluator 600 may calculate the identification ratio of the number of identified images to the number of query images at a percent rate by dividing the identification ratio by each region of interest and evaluate the accuracy of the still image identify technology at a percent rate.

Further, the evaluator 600 may calculate the identification ratio of the number of identified images to the number of query images at a percent rate by dividing the identification ratio by each modified function and evaluate the accuracy of the still image identify technology at a percent rate. Herein, this is called the robust evaluation.

Meanwhile, the evaluator 600 may evaluate the calculation complexity and evaluate the accuracy of the still image identify technology according to the result.

The evaluation of the calculating complexity depends on the average value calculated by the number of query images per second according to the size of the region of interest.

The detailed contents of the evaluation of the calculation complexity are as follows.

| | Number of query |
|---|---|
| Size of region of interest | image per second |
| close shot (½ or more of entire | a |
| image) | |
| middle shot (½-¼ of entire image) | b |
| full shot ( 1/9 or less of entire image) | c |
| Average | (a + b + c)/3 |

In addition, the system for certifying an image identify technology according to one embodiment of the present invention may further include an environment setting unit 200.

The environment setting unit 200 sets the evaluation environment of the image identify technology according to the certification application.

Meanwhile, the certificate application may include certificate authority information, certificate applicant information, and general information of image identify technology.

The detailed contents of a certificate application are as follows.

| | |
|---|---|
| Certificate authority | Certificate authority name |
| information | Certificate authority address |
| | Certificate authority serial number |
| Certification applicant | Certificate applicant name |
| information | Certificate applicant address |
| | Certificate applicant identification number |
| Still image identify | Technology number |
| technology information | Patent (optional) |
| of region of interest | Algorithm description |
| | Target application |

The certificate authority information may include at least one of certificate authority name information, certificate authority address information, and certificate authority serial number.

In addition, the certificate authority name information may include the name information on the certification authority.

Further, the certificate authority address information may include zip code and country, city/province, and address information to which the certificate authority belongs.

Further, the certificate authority serial number may be the serial number information by differentiating the certificate authority from other certificate authorities.

Meanwhile, the certificate applicant information may be at least one of the certificate applicant name information, the certificate applicant address information, and the certificate applicant identification information.

Further, the certificate applicant name information may be a name or a corporate name information of the image identify technology owner.

Further, the certificate applicant address information may include address information such as country, city/province, address, zip code, etc.

In addition, the certificate applicant identification number information may include a resident registration number and a business license number.

Meanwhile, the image identify technology information may include at least one of technology number information, patent information, algorithm description information, and target application information.

The technology number information is number information that can identify the image identify technology from other technologies.

The patent information is the patent information related to the image identification technology.

The algorithm description information is information describing an algorithm related to the image identification technology.

The target application information is application information related to the image identify technology such as search, copyright information, contents linking, metadata and fingerprinting, etc.

Meanwhile, the evaluator 600 may evaluate the accuracy of the image identify technology according to the statistical information and the evaluation environment.

In addition, the certificate generator 700 may generate certification using the statistical information and the accuracy.

The detailed contents of the certification are as follows.

A. Evaluation Result Certification (A): Calculation Complexity and Identifier Size

| | Size of region of | Number of compared |
|---|---|---|
| Classification | interest | images per second |
| Calculation | Close shot (½ or | a |
| complexity | more of entire image) | |
| | Middle shot (½-¼ | b |
| | of entire image) | |
| | Full shot ( 1/9 or | c |
| | less of entire image) | |
| | average | (a + b + c)/3 |
| Size of | | |
| Identifier (Byte) | | |

Meanwhile, the size of the identifier represents the size of feature representing the region of interest as a byte.

B. Evaluation Certificate (B); Identification Rate 1

| | Identification |
|---|---|
| Genre | rate 1(%) |
| A. Animal (picture concerning animal) | |
| B. Plant (picture concerning flower, tree, | |
| etc.) | |
| C. Food (picture concerning foods) | |
| D. Character (picture concerning | |
| person/character) | |
| E. Traffic (picture concerning traffic | |
| means, such as car, train, plane, ship) | |
| F. Building (picture concerning building) | |
| G. Thing (picture concerning thing such as | |
| clothes, shoes, bag, TV, etc.) | |
| H. Landscape (picture concerning landscape | |
| having no specific object) | |
| I. Frame sampling of HD 1080i(1920 × 1080) | |
| 16:9, 30 fps digital film | |
| J. Frame sampling of HD 720p (1280 × 720) | |
| 16:9 60 fps digital film | |

C. Evaluation Result Certification (C): Identification Rate 2

| | Size of | | Identification | | |
|---|---|---|---|---|---|
| Division | region | | rate 2(%) | | |
| Modified | of | | No. | In No. | In No. |
| type | interest | Modified level | 1 | 10 | 100 |
| 1. color−> | ½ or | I = 0.299R + | | | |
| black-and- | more | 0.587G + 0.114B | | | |
| white | | (I: Intensity, R: | | | |
| conversion | | Red, G: Green, | | | |
| (C2M) | | B: Blue) | | | |
| | ½-¼ | I = 0.299R + | | | |
| | | 0.587G + 0.114B | | | |
| | 1/9 or | I = 0.299R + | | | |
| | less | 0.587G + 0.114B | | | |
| 2. rotation | ½ or | 90° | | | |
| | more | 5° | | | |
| | | 10° | | | |
| | ½-¼ | 90° | | | |
| | | 5° | | | |
| | | 10° | | | |
| | 1/9 or | 90° | | | |
| | less | 5° | | | |
| | | 10° | | | |
| 3. pan | ½ or | 5° | | | |
| | more | 15° | | | |
| | | 30° | | | |
| | ½-¼ | 5° | | | |
| | | 15° | | | |
| | | 30° | | | |
| | 1/9 or | 5° | | | |
| | less | 15° | | | |
| | | 30° | | | |
| 4. tilt | ½ or | 5° | | | |
| | more | 10° | | | |
| | | 15° | | | |
| | ½-¼ | 5° | | | |
| | | 10° | | | |
| | | 15° | | | |
| | 1/9 or | 5° | | | |
| | less | 10° | | | |
| | | 15° | | | |
| 5. occlusion | ½ or | No occlusion | | | |
| | more | 15% of ROI | | | |
| | | 30% of ROI | | | |
| | ½-¼ | No occlusion | | | |
| | | 15% of ROI | | | |
| | 1/9 or | No occlusion | | | |
| | less | | | | |
| 6. complex | ½ or | (3)&(4) light | | | |
| modification | more | (3)&(4) medium | | | |
| | | (3)&(4) medium& (6) | | | |
| | | medium | | | |
| | ½-¼ | (3)&(4) light | | | |
| | | (3)&(4) medium | | | |
| | | (3)&(4) medium& (6) | | | |
| | | medium | | | |
| | 1/9 or | (3)&(4) light | | | |
| | less | (3)&(4) medium | | | |
| | | (3)&(4) medium& (6) | | | |
| | | medium | | | |
| | Size of | | Identification | | |
| Division | region | | rate 1(%) | | |
| Modified | of | Modification | | In No. | In No. |
| type | interest | case | No. 1 | 10 | 100 |
| 7. Weather, | ½ or | Rain | | | |
| Lighting | more | Sunset | | | |
| | | Flash | | | |
| | | Indoor | | | |
| | ½-¼ | Rain | | | |
| | | Sunset | | | |
| | | Flash | | | |
| | | Indoor | | | |
| | 1/9 or | Rain | | | |
| | less | Sunset | | | |
| | | Flash | | | |
| | | Indoor | | | |
| 8. Frame | ½ or | 2 second interval | | | |
| sampling of | more | 5 second interval | | | |
| HD 1080i | | 10 second interval | | | |
| digital | ½-¼ | 2 second interval | | | |
| film | | 5 second interval | | | |
| | | 10 second interval | | | |
| | 1/9 or | 2 second interval | | | |
| | less | 5 second interval | | | |
| | | 10 second interval | | | |
| 9. Frame | ½ or | 5 second interval | | | |
| sampling of | more | 10 second interval | | | |
| HD 720p | | 15 second interval | | | |
| digital | ½-¼ | 5 second interval | | | |
| film | | 10 second interval | | | |
| | | 15 second interval | | | |
| | 1/9 or | 5 second interval | | | |
| | less | 10 second interval | | | |
| | | 15 second interval | | | |

While certain embodiments have been described above, it will be understood to those skilled in the art that the embodiments described can be modified into various forms without changing technical spirits or essential features. For example, the method for certifying an image identify technology proposed in the present invention may be implemented in various forms. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for certifying an image identify technology, comprising:
a test image DB that stores still images and moving images;
a modified image generator that generates modified images from the still images and the moving images;
a modified image DB that stores the modified images;
a statistical information unit that calculates statistical information by using results identifying the still images, the moving images, and the modified images by the image identify technology;
an evaluator that evaluates the accuracy of the image identify technology according to the statistical information; and
a certificate generator that generates certificate by using the statistical information and the accuracy.

2. The system for certifying an image identify technology according to claim 1, wherein the modified image generator sets a region of interest for calculating the accuracy of the image identify technology and generates the modified image for each region of interest from the still images and the moving images; and
the statistical information unit calculates statistical information by further using results identifying the modified images for each region of interest by the image identification technology.

3. The system for certifying an image identify technology according to claim 2, wherein the modified image generator selects a modified function to generate the modified image for each region of interest from the still images and the moving images.

4. The system for certifying an image identify technology according to claim 3, wherein the modified function applies at least one of black-and-white conversion, rotation, pan, tilt, occlusion, and complex modification to the still images and the moving images; and
the complex modification is a case when at least two of black-to-white conversion, rotation, pan, tilt, occlusion, and complex modification are applied in combination.

5. The system for certifying an image identify technology according to claim 3, wherein the statistical information unit uses the still images and the moving images as the query image and uses the modified images as the query target image to allow the image identify technology to identify the image corresponding to the query image among the query target images, thereby calculating the statistical information using the identified results.

6. The system for certifying an image identify technology according to claim 3, wherein the statistical information unit uses the modified image as the query image and uses the still image and the moving image as the query target image to allow the image identify technology to identify the image corresponding to the query image among the query target images, thereby calculating the statistical-information using the identified results.

7. The system for certifying an image identify technology according to claim 6, wherein the evaluator calculates the identification ratio of the number of identified images to the number of query images at a percent rate by dividing the identification ratio by each region of interest and evaluates the accuracy of the still image identify technology at a percent rate.

8. The system for certifying an image identify technology according to claim 6, wherein the statistical information unit calculates the statistical information for each modified function.

9. The system for certifying an image identify technology according to claim 8, wherein the evaluator calculates the identification ratio of the number of identified images to the number of query images at a percent rate by dividing the identification ratio by each modified function and evaluates the accuracy of the still image identify technology at a percent rate.

10. The system for certifying an image identify technology according to claim 2, wherein the modified image generator selects the still image photographing environment and generates the modified images for each region of interest corresponding to the still image photographing environment from the still images.

11. The system for certifying an image identify technology according to claim 2, wherein the modified image generator selects the resolution of the moving images and frames per second to generate the modified image for each region of interest corresponding to the resolution of the moving image and the frames per second from the moving image.

12. A system for certifying a still image identify technology, comprising:
a receiver that receives an image identify technology and certificate application from a user;
an environment setting unit that sets an evaluation environment of the image identify technology according to the certificate application;
a test image DB that stores still images and moving images;
a modified image generator that sets regions of interest in the still images and the moving images, respectively, and modifies the set regions of interest to generate the modified images for each region of interest for the still images and the moving images;
a statistical information unit that calculates statistical information by using the results identifying the still images, the moving images, and the modified images for each region of interest by the image identify technology;
an evaluator that evaluates the accuracy of the image identify technology according to the statistical information and the evaluation environment; and
a certificate generator that generates certificate using the statistical information and the accuracy.

13. The system for certifying a still image identify technology according to claim 12, wherein the statistical information unit uses the still images and the moving images as the query image and uses the modified images as the query target image to allow the image identify technology to identify the image corresponding to the query image among the query target images, thereby calculating the statistical information using the identified results.

14. The system for certifying a still image identify technology according to claim 12, wherein the statistical information unit uses the modified image as the query image and uses the still image and the moving image as the query target image to allow the image identify technology to identify the image corresponding to the query image among the query target images, thereby calculating the statistical information using the identified results.

15. The system for certifying a still image identify technology according to claim 14, wherein the evaluator calculates the identification ratio of the number of identified images to the number of query images at a percent rate by dividing the identification ratio by each region of interest and evaluates the accuracy of the still image identify technology at a percent rate.

16. The system for certifying a still image identify technology according to claim 14, wherein the modified image generator selects a modified function to generate the modified image for each region of interest from the still images and the moving images.

17. The system for certifying a still image identify technology according to claim 16, wherein the modified function applies to at least one of black-to-white conversion, rotation, pan, tilt, occlusion, and complex modification to the still images and the moving images, and
the complex modification is a case when at least two of the black-to-white conversion, rotation, pan, tilt, occlusion, and complex modification are applied in combination.

18. The system for certifying a still image identify technology according to claim 17, wherein the statistical information unit calculates the statistical information for each modified function.

19. The system for certifying a still image identify technology according to claim 16, wherein the evaluator calculates the identification ratio of the number of identified images to the number of query images at a percent rate by dividing the identification ratio by each modified function and evaluates the accuracy of the still image identify technology at a percent rate.
